(19) United States
(12) Patent Application Publication
(10) Pub. No.: US 2020/0400707 A1
(43) Pub. Date: Dec. 24, 2020

(54) PIEZOELECTRIC SENSOR

(71) Applicant: FATRI (Xiamen) Technologies Co., Ltd., Xiamen City (CN)

(72) Inventor: Ying GAO, Xiamen City (CN)

(73) Assignee: FATRI (Xiamen) Technologies Co., Ltd., Xiamen City (CN)

(21) Appl. No.: 16/568,268

(22) Filed: Sep. 12, 2019

(30) Foreign Application Priority Data
Jun. 21, 2019 (CN) 201920940627.3

(51) Int. Cl. G01P 15/09; G01P 15/08; G01L 1/16; G01P 1/02

(52) U.S. Cl. CPC G01P 15/09; G01P 1/023; G01L 1/162; G01P 15/0802

(57) ABSTRACT

The disclosure provides a piezoelectric sensor including a connector and a charge output element. The connector includes a connector housing and a conductive terminal interposed inside the connector housing. The connector housing and the conductive terminal are connected by a first insulating layer. The charge output element includes a base including opposite axially top and bottom ends. A first recess is provided at the top end of the base. A connecting member is disposed inside the first recess along an axial direction of the first recess. A piezoelectric element, a mass block and a fastener are sequentially sleeved on the connecting member. The base includes a second recess formed by recessing an outer peripheral surface of the base toward an interior of the base. The connector is connected to an inner wall of the second recess. A recessed direction of the second recess intersects the axial direction of the base.

### CROSS-REFERENCE TO RELATED APPLICATION

This application is based on and claims priority to Chinese Patent Application No. 201920940627.3 filed on Jun. 21, 2019, which is incorporated herein by reference in its entirety.

### TECHNICAL FIELD

The disclosure relates to the technical field of sensor, and in particular to a piezoelectric sensor.

### BACKGROUND

Piezoelectric sensors are used more and more widely to measure the vibration of an object. The piezoelectric acceleration sensor, also known as the piezoelectric accelerometer, belongs to an inertial sensor. The piezoelectric acceleration sensor is a sensor in which the force applied to the piezoelectric element by the mass block will change due to the piezoelectric effect of the piezoelectric element when the accelerometer is vibrated. When the detected vibration frequency is much lower than the natural frequency of the accelerometer, the change in force is proportional to the detected acceleration.

The piezoelectric accelerometers are widely used in detection systems. The urgent problem to be solved is how to improve the transmission accuracy of electrical signal and ensure detection accuracy.

### SUMMARY

In one aspect, an embodiment of the disclosure provides a piezoelectric sensor including: including a connector including a connector housing and a conductive terminal interposed inside the connector housing, wherein the connector housing and the conductive terminal are connected by a first insulating layer; and a charge output element including a base, wherein the base includes a top end and a bottom end which are opposite in an axial direction of the base, a first recess is provided at the top end of the base, a connecting member is disposed inside the first recess and extends along an axial direction of the first recess, a piezoelectric element, a mass block and a fastener are sequentially sleeved on the connecting member along an axial direction of the connecting member, the base is provided with a second recess for mounting the connector, the second recess is formed by recessing an outer peripheral surface of the base toward an interior of the base, the connector is connected to an inner wall of the second recess by the second insulating layer, and a recessed direction of the second recess intersects the axial direction of the base.

According to an aspect of an embodiment of the disclosure, the connecting member is disposed at a center position of the first recess and extends in the axial direction of the base, and the base and the connecting member are integrally formed.

According to an aspect of an embodiment of the disclosure, a thread is provided on an outer surface at one end of the connector housing, the other end of the connector housing is inserted into an interior of the second recess and is connected to the inner wall of the second recess by the first insulating layer, a first wire connecting hole is provided at an end of the connector housing located inside the second recess and penetrates the connector housing, and a second wire connecting hole is provided at an end of the conductive terminal located within the first recess and penetrates the conductive terminal.

According to an aspect of an embodiment of the disclosure, the first insulating layer includes a first insulating ceramic layer and a first glass layer which are successively arranged in an axial direction of the conductive terminal, and the first insulating ceramic layer and the first glass layer are both disposed around a circumference of the conductive terminal; and the second insulating layer is disposed around a circumference of the connector housing.

According to an aspect of an embodiment of the disclosure, an inserting hole is provided at an end of the conductive terminal away from the first recess along an axial direction of the conductive terminal, the inserting hole has a length H1 in the axial direction of the conductive terminal, the conductive terminal has a length H in the axial direction of the conductive terminal, and the length H1 of the inserting hole and the length H of the conductive terminal satisfy following relationship: H1:H=2:5˜1:3; a third recess is disposed on a sidewall of the inserting hole along the axial direction of the conductive terminal, the third recess has a length H2 in the axial direction of the conductive terminal, and the length H2 of the third recess and the length H of the conductive terminal satisfy following relationship: H2:H=3:4˜1:2; and the first insulating ceramic layer has a length H3 in the axial direction of the conductive terminal, and the length H of the conductive terminal and the length H3 of the first insulating ceramic layer satisfy following relationship: H:H3=1:1˜1:1.5.

According to an aspect of an embodiment of the disclosure, the piezoelectric element, the mass block, and the fastener extends along the axial direction of the base, and the piezoelectric element, the mass block, and the fastener are each disposed around a circumference of the connecting member.

According to an aspect of an embodiment of the disclosure, the conductive terminal, the first insulating layer, the connector housing, and the second insulating layer are all disposed coaxially; the base, the first recess, the connecting member, the piezoelectric element, the mass block, and the fastener are all disposed coaxially; and an axial direction of the conductive terminal and the axial direction of the base are perpendicular to each other.

According to an aspect of an embodiment of the disclosure, the piezoelectric element includes a top end and a bottom end which are opposite in an axial direction thereof, and the top end of the piezoelectric element abuts against the mass block through an insulating layer, and the bottom end of the piezoelectric element abuts against the base through the insulating layer; and the piezoelectric element includes a plurality of piezoelectric ceramic layers which are laminated one on another, an electrode layer is disposed between two adjacent piezoelectric ceramic layers, and the two adjacent electrode layers have opposite polarities.

According to an aspect of the embodiment of the disclosure, the connecting member is provided with a thread on its end away from the base, the thread has a length H4 in the axial direction of the conductive terminal, the connecting member has a length H in the axial direction of the conductive terminal, and the length H4 of the thread and the length H of the conductive terminal satisfy the following relationship: H4:H=1:2˜1:3; and the fastener is connected to the connecting member by the thread.

According to an aspect of an embodiment of the disclosure, the piezoelectric sensor further includes a casing that is open at one end, the first recess is provided with a casing mounting slot at an end of its sidewall away from the base, the open end of the casing and the casing mounting slot are connected to form a casing having a receiving space therein, the connecting member and the piezoelectric element, the mass block and the fastener sleeved on the connecting member are disposed within the receiving space, and the casing mounting slot has a cross section of “L-shaped” or “V-shaped” or “trapezoidal” in an axial direction thereof.

Embodiments of the disclosure provide a piezoelectric sensor in which a first insulating layer is disposed between the connector housing and the conductive terminal, so that when the piezoelectric element transfers a charge to the conductive terminal of the connector, the output of an electrical signal of the charge output element is realized. The second insulating layer is disposed between the connector housing and the casing of the piezoelectric sensor, thereby ensuring insulation between the connector housing and the casing of the piezoelectric sensor, ensuring grounding of the charge output component through the connector housing, preventing the potential of the casing of the piezoelectric sensor from affecting the grounding end of the charge output element, and improving the detection accuracy of the piezoelectric acceleration sensor.

### BRIEF DESCRIPTION OF THE DRAWINGS

In order to more clearly illustrate the technical solution according to the embodiments of the disclosure, the drawings used in the embodiments of the disclosure will be briefly described below. It is apparent that the drawings described below are only some implementations of the disclosure, and other drawings may be obtained by those of ordinary skill in the art without any inventive labor.

FIG. 1 is a perspective view of a piezoelectric sensor according to an embodiment of the disclosure;

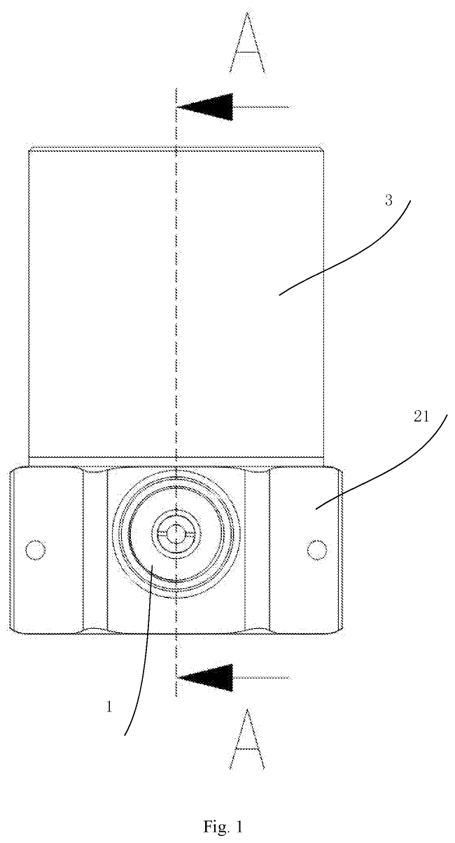

FIG. 2 is a cross-sectional view taken along the line A-A of a piezoelectric sensor according to an embodiment of the disclosure;

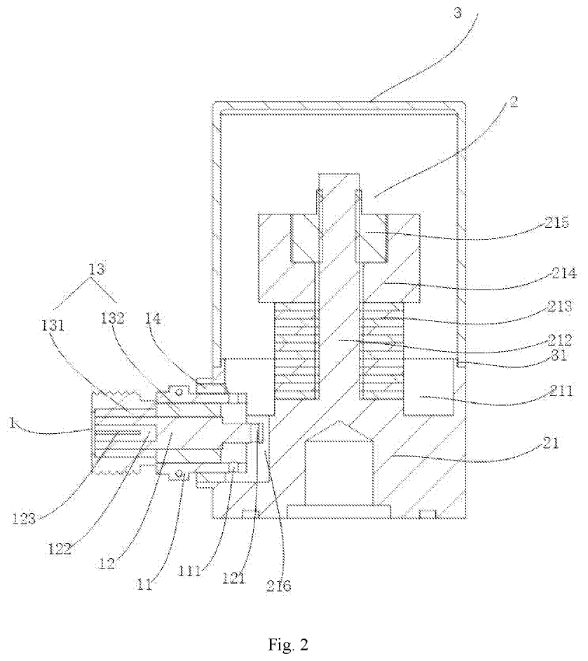

FIG. 3 is another perspective view of a piezoelectric sensor according to an embodiment of the disclosure.

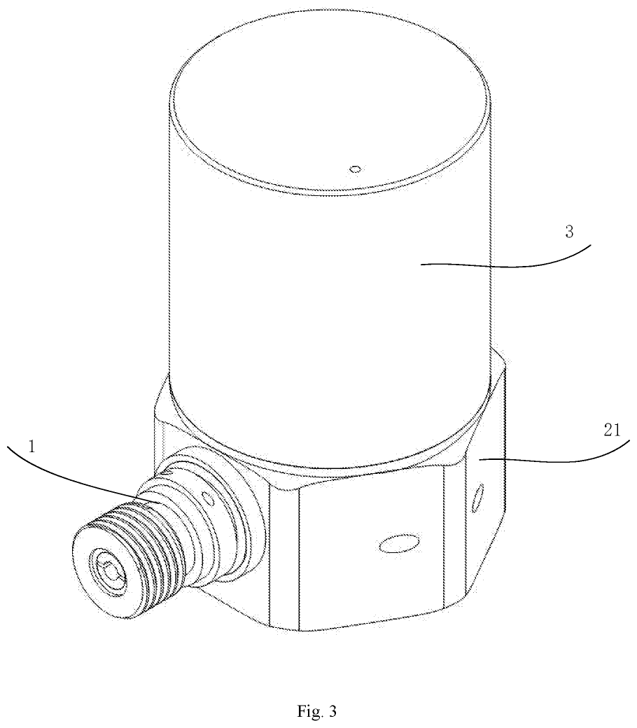

Description of Reference Signs:

| | | | |
|---|---|---|---|
| 1 | connector; | 11 | connector housing; |
| 111 | first wire connecting hole; | 12 | conductive terminal; |
| 121 | second wire connecting hole; | 122 | inserting hole; |
| 123 | third recess; | 13 | first insulating layer; |
| 131 | first insulating ceramic layer; | 132 | first glass layer; |
| 14 | second insulating layer; | 2 | charge output element; |
| 21 | base; | 211 | first recess; |
| 212 | connector; | 213 | piezoelectric element; |
| 214 | mass block; | 215 | fastener; |
| 216 | second recess; | 3 | casing; |
| 31 | casing mounting slot. | | |

### DETAILED DESCRIPTION

Features and exemplary embodiments according to various aspects of the disclosure are described in detail below. In order to make the objects, technical solutions and advantages of the disclosure more apparent, the disclosure will be further described in detail below with reference to the drawings and specific embodiments. It should be appreciated that the specific embodiments described herein are only to be construed as illustrative rather than restrictive. The disclosure may be practiced without some of these specific details. The following description of the embodiments is merely to provide a better understanding of the disclosure.

It should be noted that, relational terms herein such as first, second, and the like are used merely to distinguish one entity or operation from another entity or operation, and any such actual relationship or order between these entities or operations is not necessarily required. Furthermore, the terms “comprises”, “includes” or any other variations thereof is intended to encompass a non-exclusive inclusion, so that a process, method, item, or device including a series of elements includes not only these elements but also other elements that are not explicitly listed, or elements that are inherent to such process, method, item, or device. The elements defined by the phrase “including”, without further limitation, do not exclude the presence of additional equivalent elements in the process, method, item, or device.

In order to solve the problem in prior art, an embodiment of the disclosure provides a piezoelectric sensor including a connector 1 and a charge output element 2. The connector 1 includes a connector housing 11 and a conductive terminal 12 disposed inside the connector housing 11. The connector housing 11 and the conductive terminal 12 are connected by a first insulating layer 13. The charge output element 2 includes a base 21. The base 21 has a top end and a bottom end which are opposite in an axial direction thereof. A first recess 211 is provided at the top end of the base 21, and a connecting member 212 is provided within the first recess 211 and extends along an axial direction of the first recess 211. A piezoelectric element 213, a mass block 214, and a fastener 215 are sequentially sleeved on the connecting member 212 along an axial direction of the connecting member 212. The base 21 is provided with a second recess 216 for mounting the connector 1, and the second recess 216 is formed by recessing an outer peripheral surface of the base 21 toward an interior of the base 21. The connector 1 is connected to an inner wall of the second recess 216 through a second insulating layer 14. A recessed direction of the second recess 216 intersects the axial direction of the base 21.

Specifically, the piezoelectric element 213 is electrically connected to the connector housing 11 through the first wire, and the piezoelectric element 213 is electrically connected to the conductive terminal 12 through the second wire. One of the two electrodes of the piezoelectric element 213 is connected to the conductive terminal 12 of the connector 1, so that the output of the electrical signal of the charge output element 2 can be achieved. The other of the two electrodes of the piezoelectric element 213 is connected to the connector housing 11 and the connector housing 11 is insulated from a casing 3 of the piezoelectric acceleration sensor, so that the grounding of the charge output element 2 can be ensured by the connector housing 11, the influence of the potential of the casing 3 on the grounding end of the charge output element 2 can be avoided, and the detection accuracy of the piezoelectric acceleration sensor can be ensured. Further, the connecting member 212 is disposed at the top end of the base 21, the piezoelectric element 213, the mass block 214, and the fastener 215 are sequentially disposed on the connecting member 212 along the axial direction of the connecting member 212, the piezoelectric element 213 and the mass block 214 is fixed to the connecting member 212 by the fastener 215, and the piezoelectric element 213 is fixed within the casing 3 by the fastener 215. Therefore, the installation is simple, the disassembly and maintenance are facilitated, and the rigidity of the whole structure is greatly improved, and the frequency response characteristic is good. The axial direction of the connecting member 212, the axial direction of the first recess 211 and the axial direction of the base 21 are parallel to each other or coincide with other. A mounting hole is provided in the bottom end of the base 21 and is coaxial with the piezoelectric element 213. The mounting hole is recessed in the axial direction of the base 21 toward an interior of the base 21, and the mounting hole is used to connect the external device, thereby fixing the piezoelectric sensor to the external device.

Alternatively, the axial direction of the connecting member 212, the axial direction of the first recess 211 and the axial direction of the base 21 coincide with each other. Therefore, the stability of the charge output element 2 can be improved.

In some alternative embodiments, the connecting member 212 is disposed at a center position of the first recess 211 and extends in the axial direction of the base 21. The base 21 and the connecting member 212 are integrally formed. Therefore, the overall structure of the charge output element 2 can be simplified, the overall strength of the charge output element 2 can be improved, and the process flow can be reduced.

In some alternative embodiments, the connector housing 11 is provided with a thread on an outer surface at one end, and the other end of the connector housing 11 is inserted into the interior of the second recess 216 and is connected to the inner wall of the recess 216 through the second insulating layer 14. A first wire connecting hole 111 is provided at the end of the connector housing 11 located inside the first recess 211 and penetrates the connector housing 11, and a second wire connecting hole 121 is provided at the end of the conductive terminal 12 located inside the first recess 211 and penetrates the conductive terminal 12.

Further, the first wire connecting hole 111 disposed in the connector housing 11 is used for connecting the first wire, ensuring that the grounding of the charge output element 2 can be realized through the connector housing 11, avoiding the influence of the potential of the casing 3 on the grounding end of the charge output element 2, and improving the detection accuracy of the piezoelectric acceleration sensor. The second wire connecting hole 121 is disposed in the conductive terminal 12 and penetrates the conductive terminal 12, so that the output of the electrical signal of the charge output element 2 is realized and the detection accuracy of the piezoelectric acceleration sensor is improved when the piezoelectric element 213 transfers charge to the conductive terminal 12 of the connector 1. The second recess 216 is in communication with the first recess 211 to form a communication region, and the first wire and the second wire communicate with the piezoelectric element 213 and the connector 1 through the communication region. Alternatively, the axial direction of the first recess 211 and the axial direction of the second recess 216 are perpendicular.

In some alternative embodiments, the first insulating layer 13 includes a first insulating ceramic layer 131 and a first glass layer 132 that are successively arranged along the axial direction of the conductive terminal 12. The first insulating ceramic layer 131 and the first glass layer 132 are both disposed around a circumference of the conductive terminal 12. The second insulating layer 14 is disposed around a circumference of the connector housing 11.

Specifically, the connector housing 11 includes an inner surface facing the conductive terminal 12 and an outer surface facing away from the conductive terminal 12, and the first insulating ceramic layer 131 includes an inner surface facing the conductive terminal 12 and an outer surface facing away from the conductive terminal 12. The inner surface of the first insulating ceramic layer 131 is in contact with an insulating terminal, and the outer surface of the first insulating ceramic layer 131 is attached to the inner surface of the connector housing 11. The first glass layer 132 includes an inner surface facing the conductive terminal 12 and an outer surface facing away from the conductive terminal 12. The inner surface of the first glass layer 132 is in contact with the conductive terminal 12, and the outer surface of the first glass layer 132 is attached to the inner surface of the connector housing 11. The first glass layer 132 and the connector housing 11 are bonded by glass glue. The inner surface of the second insulating layer 14 is attached to the outer surface of the connector housing 11, and the outer surface of the second insulating layer 14 is in contact with the casing 3 of the piezoelectric sensor. Thereby, the insulation between connector housing 11 and the casing 3 of the piezoelectric sensor are further ensured.

In some alternative embodiments, an inserting hole 122 is provided at the end of the conductive terminal 12 away from the first recess 211 and extends along the axial direction of the conductive terminal 12. In the axial direction of the conductive terminal 12, the length H1 of the inserting hole 122 and the length H of the conductive terminal 12 satisfy the following relationship: H1:H=2:5˜1:3. A third recess 123 is provided on a sidewall of the inserting hole 122 and extends along the axial direction of the conductive terminal 12. In the axial direction of the conductive terminal 12, the length H2 of the third recess 123 and the length H of the conductive terminal 12 satisfy the following relationship: H2:H=3:4˜1:2. In the axial direction of the conductive terminal 12, the length H of the conductive terminal 12 and the length H3 of the first insulating ceramic layer 131 satisfy the following relationship: H:H3=1:1˜1:1.5.

Alternatively, in the axial direction of the conductive terminal 12, the length H1 of the inserting hole 122 and the length H of the conductive terminal 12 satisfy the following relationship H1:H=1:1.5. Therefore, the inserting hole 122 disposed at one end of the conductive terminal 12 can be connected to the external plug-in device and the plug-in device is in turn connected to the external device to be detected, so that the detection of the external device can be realized by the piezoelectric sensor, the stability of the contact between the device to be detected and the piezoelectric sensor can be ensured, and the detection accuracy can be improved. Alternatively, in the axial direction of the conductive terminal 12, the length H2 of the third recess 123 and the length H of the conductive terminal 12 satisfy the following relationship: H2:H=1:3, so that the detection accuracy can be improved. Alternatively, in the axial direction of the conductive terminal 12, the length H of the conductive terminal 12 and the length H3 of the first insulating ceramic layer 131 satisfy the following relationship: H:H3=1:1, so that insulation between the connector housing 11 and the casing 3 of the piezoelectric sensor can be ensured, and the grounding of the charge output element 2 can be achieved by the connector housing 11.

In some alternative embodiments, the piezoelectric element 213, the mass block 214, and the fastener 215 extend along the axial direction of the base 21, and the piezoelectric element 213, the mass block 214, and the fastener 215 are each disposed around the circumference of the connecting member 212.

In some alternative embodiments, the conductive terminal 12, the first insulating layer 13, the connector housing 11 and the second insulating layer 14 are all coaxially disposed. The base 21, the first recess 211, the connecting member 212, and the piezoelectric element 213, the mass block 214, and the fastener 215 are all disposed coaxially. The axial direction of the conductive terminal 12 and the axial direction of the base 21 are perpendicular to each other.

In some alternative embodiments, the piezoelectric element 213 includes a top end and a bottom end which are opposite in an axial direction thereof, and the top end of the piezoelectric element 213 abuts against the mass block 214 through the insulating layer, and the bottom end of the piezoelectric element 213 abuts against the base 21 through the insulating layer. The piezoelectric element 213 includes a plurality of piezoelectric ceramic layers which are laminated one on another, and an electrode layer is disposed between two adjacent piezoelectric ceramic layers.

Further, a central through hole is provided in the piezoelectric element 213 and the mass block 214, and the connecting member 212 is fastened to the piezoelectric element 213 and the mass block 214 through the central through hole. The wall of the central through hole in the piezoelectric element 213 and the mass block 214 are insulated from or gap-fitted with the connecting member 212. The piezoelectric element 213 has a property that the piezoelectric coefficient increases as the temperature rises. The electrode layer is disposed between two adjacent piezoelectric ceramic layers, and the two adjacent electrode layers have opposite polarity. The material of the electrode layer may be a nickel-based alloy. The piezoelectric ceramic structure is provided with an insulating layer on either of the two end faces of the axial direction thereof. Therefore, it is possible to effectively prevent the electric charge from being exposed and improve the overall electrical conductivity of the piezoelectric ceramic component. The insulating layer may be an alumina ceramic sheet.

In some alternative embodiments, the connecting member 212 is provided with a thread on its end away from the base 21, and in the axial direction of the conductive terminal 12, the length H4 of the thread and the length H of the connecting member 212 satisfy the following relationship: H4:H=1:2˜1:3. The fastener 215 is connected to the connecting member 212 by the thread.

Specifically, the connecting member 212 is provided with a thread for connecting the external device to be detected, and the piezoelectric sensor is connected to the device to be detected by the thread, which is convenient for disassembly. Alternatively, the length H4 of the thread and the length H of the connecting member 212 satisfy the following relationship: H4:H=1:3.

In some alternative embodiments, the piezoelectric sensor further includes a casing 3 that is open at one end. The first recess 211 is provided with a casing mounting slot 31 at an end of its sidewall away from the base 21, and the open end of the casing 3 and the casing mounting slot 31 are connected to form the casing having a receiving space therein. Within the receiving space, the connecting member 212, and the piezoelectric element 213, the mass block 214 and the fastener 215 sleeved on the connecting member 212 are disposed. The casing mounting slot 31 has a cross section of “L-shaped” or “V-shaped” or “trapezoidal” in an axial direction thereof.

The disclosure may be embodied in other specific forms without departing from the spirit and essential characteristics of the disclosure. For example, the algorithms described in the specific embodiments may be modified, and the system architecture does not depart from the basic spirit of the disclosure. Therefore, the above mentioned embodiments are to be considered in all respects as illustrative rather than restrictive. The scope of the disclosure is defined by the appended claims rather than the foregoing description, and all modifications within the scope of the claims and the equivalents thereof are intended to be included within the scope of the disclosure.

What is claimed is:

1. A piezoelectric sensor, comprising:
a connector comprising a connector housing and a conductive terminal interposed inside the connector housing, wherein the connector housing and the conductive terminal are connected by a first insulating layer; and
a charge output element comprising a base, wherein the base comprises a top end and a bottom end which are opposite in an axial direction of the base, a first recess is provided at the top end of the base, a connecting member is disposed inside the first recess and extends along an axial direction of the first recess, a piezoelectric element, a mass block and a fastener are sequentially sleeved on the connecting member along an axial direction of the connecting member, the base is provided with a second recess for mounting the connector, the second recess is formed by recessing an outer peripheral surface of the base toward an interior of the base, the connector is connected to an inner wall of the second recess by the second insulating layer, and a recessed direction of the second recess intersects the axial direction of the base.

2. The piezoelectric sensor according to claim 1, wherein the connecting member is disposed at a center position of the first recess and extends in the axial direction of the base, and the base and the connecting member are integrally formed.

3. The piezoelectric sensor according to claim 1, wherein a thread is provided on an outer surface at one end of the connector housing, the other end of the connector housing is inserted into an interior of the second recess and is connected to the inner wall of the second recess by the first insulating layer, a first wire connecting hole is provided at an end of the connector housing located inside the second recess and penetrates the connector housing, and a second wire connecting hole is provided at an end of the conductive terminal located within the first recess and penetrates the conductive terminal.

4. The piezoelectric sensor according to claim 1, wherein the first insulating layer comprises a first insulating ceramic layer and a first glass layer which are successively arranged in an axial direction of the conductive terminal, and the first insulating ceramic layer and the first glass layer are both disposed around a circumference of the conductive terminal; and
the second insulating layer is disposed around a circumference of the connector housing.

5. The piezoelectric sensor according to claim 1, wherein an inserting hole is provided at an end of the conductive terminal away from the first recess along an axial direction of the conductive terminal, the inserting hole has a length H1 in the axial direction of the conductive terminal, the conductive terminal has a length H in the axial direction of the conductive terminal, and the length H1 of the inserting hole and the length H of the conductive terminal satisfy following relationship: H1:H=2:5˜1:3;
a third recess is disposed on a sidewall of the inserting hole along the axial direction of the conductive terminal, the third recess has a length H2 in the axial direction of the conductive terminal, and the length H2 of the third recess and the length H of the conductive terminal satisfy following relationship: H2:H=3:4˜1:2; and
the first insulating ceramic layer has a length H3 in the axial direction of the conductive terminal, and the length H of the conductive terminal and the length H3 of the first insulating ceramic layer satisfy following relationship: H:H3=1:1˜1:1.5.

6. The piezoelectric sensor according to claim 1, wherein the piezoelectric element, the mass block, and the fastener extends along the axial direction of the base, and the piezoelectric element, the mass block, and the fastener are each disposed around a circumference of the connecting member.

7. The piezoelectric sensor according to claim 1, wherein the conductive terminal, the first insulating layer, the connector housing, and the second insulating layer are all disposed coaxially;
the base, the first recess, the connecting member, the piezoelectric element, the mass block, and the fastener are all disposed coaxially; and
an axial direction of the conductive terminal and the axial direction of the base are perpendicular to each other.

8. The piezoelectric sensor according to claim 1, wherein the piezoelectric element comprises a top end and a bottom end which are opposite in an axial direction thereof, and the top end of the piezoelectric element abuts against the mass block through an insulating layer, and the bottom end of the piezoelectric element abuts against the base through the insulating layer; and
the piezoelectric element comprises a plurality of piezoelectric ceramic layers which are laminated one on another, an electrode layer is disposed between two adjacent piezoelectric ceramic layers, and the two adjacent electrode layers have opposite polarities.

9. The piezoelectric sensor according to claim 1, the connecting member is provided with a thread on its end away from the base, the thread has a length H4 in the axial direction of the conductive terminal, the connecting member has a length H in the axial direction of the conductive terminal, and the length H4 of the thread and the length H of the conductive terminal satisfy the following relationship: H4:H=1:2˜1:3; and
the fastener is connected to the connecting member by the thread.

10. The piezoelectric sensor according to claim 1, further comprising a casing that is open at one end, the first recess is provided with a casing mounting slot at an end of its sidewall away from the base, the open end of the casing and the casing mounting slot are connected to form a casing having a receiving space therein, the connecting member and the piezoelectric element, the mass block and the fastener sleeved on the connecting member are disposed within the receiving space, and the casing mounting slot has a cross section of “L-shaped” or “V-shaped” or “trapezoidal” in an axial direction thereof.
